(19) United States
(12) Patent Application Publication
(10) Pub. No.: US 2019/0354760 A1
(43) Pub. Date: Nov. 21, 2019

(54) ELECTRONIC DEVICE, CONTROL DEVICE, AND CONTROL METHOD

(71) Applicant: SHARP KABUSHIKI KAISHA, Osaka (JP)

(72) Inventor: KENJI KIMURA, Sakai City (JP)

(21) Appl. No.: 16/412,857

(22) Filed: May 15, 2019

(30) Foreign Application Priority Data
May 18, 2018 (JP) 2018-096496

(51) Int. Cl. G06K 9/00; G06T 7/70

(52) U.S. Cl. CPC G06K 9/00671; G06F 3/0482; G06T 7/70; G06K 9/00228

(57) ABSTRACT

An electronic device including: a storage section in which image data is to be stored; a display section; and a control section, the control section being configured to perform (a) an image data obtaining process of obtaining, from the storage section, image data selected by a user, the image data being obtained as selected image data, (b) a related-word selecting process of selecting, as an image-related word, a word relevant to the selected image data, and (c) a displaying process of controlling the display section to display the image-related word and the selected image data.

This Nonprovisional application claims priority under 35 U.S.C. § 119 on Patent Application No. 2018-096496 filed in Japan on May 18, 2018, the entire contents of which are hereby incorporated by reference.

### TECHNICAL FIELD

The present invention relates to an electronic device, a control device, and a control method.

### BACKGROUND ART

Conventionally, many users use communication services such as social networking service (SNS). The users use the communication services in such a way as to, for example, post documents or the like on the communication services. Under such circumstances, there are demands for a method by which users can easily post documents or the like on the communication services.

For example, according to the comment posting support system disclosed in Patent Literature 1, a comment posted by a user on a communication system is associated with goods or services provided by the user. The comment posting support system also provides the user with a new comment corresponding to the goods or services associated with the comment posted by the user.

### CITATION LIST

### Patent Literature

[Patent Literature 1]

Japanese Patent Application Publication Tokukai No. 2012-164273 (Publication date: Aug. 30, 2012)

### SUMMARY OF INVENTION

### Technical Problem

The comment posting support system disclosed in Patent Literature 1 brings about such an effect as making it possible that, based on whether or not a user providing goods and services has posted a comment on the communication service, the user is recommended to post a comment. However, the comment posting support system disclosed in Patent Literature 1 has room of further improvement.

It is an object of an aspect of the present invention to reduce an effort and an error in a case where a user input sentences.

### Solution to Problem

In order to attain the object, an electronic device in accordance with an aspect of the present invention includes: at least one storage section in which image data is to be stored; at least one display section; and at least one control section, the at least one control section being configured to perform (a) an image data obtaining process of obtaining, from the at least one storage section, image data selected by a user, the image data being obtained as selected image data, (b) a related-word selecting process of selecting, as an image-related word, a word relevant to the selected image data, and (c) a displaying process of controlling the at least one display section to display the image-related word and the selected image data.

A control method in accordance with an aspect of the present invention is a method of controlling an electronic device, the electronic device including: at least one storage section in which image data is to be stored; at least one display section; and at least one control section, the at least one control section being configured to perform (a) an image data obtaining process of obtaining, from the at least one storage section, image data selected by a user, the image data being obtained as selected image data, (b) a related-word selecting process of selecting, as an image-related word, a word relevant to the selected image data, and (c) a displaying process of controlling the at least one display section to display the image-related word and the selected image data.

A control device in accordance with an aspect of the present invention is a control device configured to control an electronic device, the electronic device including: at least one storage section in which image data is to be stored; and at least one display section; the control device including: (a) an image data obtaining section configured to obtain, from the at least one storage section, image data selected by a user, the image data being obtained as selected image data; (b) a related-word selecting section configured to select, as an image-related word, a word relevant to the selected image data; and (c) a display processing section configured to control the at least one display section to display the image-related word and the selected image data.

### Advantageous Effects of Invention

An aspect of the present invention makes it possible to reduce an effort and an error in a case where a user inputs sentences.

### BRIEF DESCRIPTION OF DRAWINGS

FIG. 1 is a block diagram illustrating a configuration of an electronic device in accordance with Embodiment 1 of the present invention.

FIG. 2 is a block diagram illustrating a configuration of a related-word selecting section included in the electronic device illustrated in FIG. 1.

FIG. 3 is a flowchart illustrating the process performed by the electronic device illustrated in FIG. 1.

FIG. 4A is a view illustrating a content displayed by a display section included in the electronic device.

FIG. 4B is a view illustrating an image selection screen displayed by the display section.

FIG. 5A is a view showing that a menu is displayed by the display section included in the electronic device, the menu allowing an image-related word to be selected.

FIG. 5B is a view showing that an image-related word is inputted into the display section.

FIG. 6 is a block diagram illustrating a configuration of an electronic device in accordance with Embodiment 2 of the present invention.

### DESCRIPTION OF EMBODIMENTS

### Embodiment 1

(Main Configuration of Electronic Device 1)

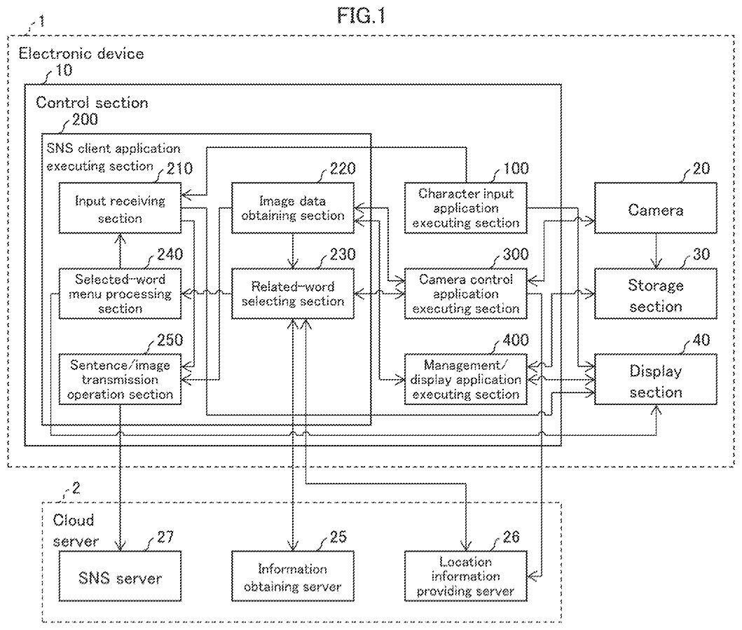

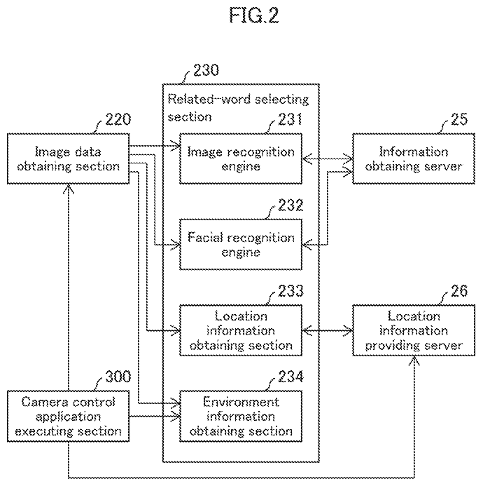

FIG. 1 is a block diagram illustrating a configuration of an electronic device 1 in accordance with Embodiment 1 of the present invention. FIG. 2 is a block diagram illustrating a configuration of a related-word selecting section 230 included in the electronic device 1. Examples of the electronic device 1 encompass an information terminal such as a smartphone.

As illustrated in FIG. 1, the electronic device 1 includes a control section 10, a camera 20, a storage section 30, and a display section 40. The electronic device 1 communicates with a cloud server 2. There can be a single control section 10 or a plurality of control sections 10. There can be a single storage section 30 or a plurality of storage sections 30. There can be a single display section 40 of a plurality of display sections 40. The scope of the present invention also encompasses a control device including the control section 10 so as to control the electronic device 1. There can be a single such control device or a plurality of such control devices.

The control section 10 includes a character input application executing section 100, an SNS client application executing section 200, a camera control application executing section 300, and a management/display application executing section (display processing section) 400.

The character input application executing section 100 performs a character input process according to an operation of a user. Note that, in connection with the character input application executing section 100, there are existing character input applications whose functions can be expanded, through a plug-in system, by unlocking expandable functions. For such an application, an expandable function can be provided through a plug-in system.

The SNS client application executing section 200 transmits, for example, a sentence and/or an image to an SNS server 27. The SNS client application executing section 200 includes an input receiving section 210, an image data obtaining section 220, the related-word selecting section 230, a selected-word menu processing section 240, and a sentence/image transmission operation section 250.

The input receiving section 210 receives a character input from the character input application executing section 100. The image data obtaining section 220 obtains, as selected image data, image data selected by a user. The image data obtaining section 220 obtains the image data from the storage section 30 via a management/display application executing section 400.

The related-word selecting section 230 selects, as an image-related word, a word relevant to the selected image data. As illustrated in FIG. 2, the related-word selecting section 230 includes an image recognition engine 231, a facial recognition engine 232, a location information obtaining section 233, and an environment information obtaining section 234.

The image recognition engine 231 recognizes, from the image data, subject-related information concerning a subject included in the selected image data obtained from the storage section 30. The facial recognition engine 232 recognizes, from the image data, facial information concerning the face of a person who is the subject included in the image data. The following methods are well known, and therefore will not be described herein: (i) a method in which the image recognition engine 231 recognizes subject-related information from image data and (ii) a method in which the facial recognition engine 232 recognizes the facial information from image data.

The location information obtaining section 233 obtains, as information indicating a location at which the image data was captured, location information associated with the image data. The environment information obtaining section 234 obtains, as information indicating an environment in which the image data was captured, environment information associated with the image data. In addition, the environment information obtaining section 234 obtains data related to settings of the camera 20, which settings are set by the camera control application executing section 300.

The selected-word menu processing section 240 performs a process of causing the display section 40 to display the image-related word as a menu. The sentence/image transmission operation section 250 performs an operation to transmit a sentence and/or an image to the SNS server 27.

The camera control application executing section 300 controls the camera 20 to set the camera 20. The management/display application executing section 400 is configured to (i) cause the display section 40 to display image data which is stored in the storage section 30 and (ii) select the image data.

The camera 20 is an image-capturing device configured to capture an image of the outside of the electronic device 1. The storage section 30 stores image data or the like which was generated by capturing, with use of the camera 20, the image of the outside of the electronic device 1. The display section 40 is, for example, a display, and displays (i) the image data and/or (ii) characters or the like inputted by the character input application executing section 100.

The cloud server 2 includes an information obtaining server 25, a location information providing server 26, and the SNS server 27. The cloud server 2 is, for example, a cloud service which, without a need for attention to a location of data or software, can (i) provide a plurality of devices, which are connected to a network, with respective functions and (ii) allow necessary information to be extracted as needed.

The information obtaining server 25 is a server configured to obtain, via the Internet, information which cannot be obtained inside the electronic device 1. The location information providing server 26 is a server configured to (i) refer to the location information obtained by the location information obtaining section 233 and (ii) obtain, via the Internet, a name of a location concerning the location information. The SNS server 27 is a server which provides various services, based on the data received from the electronic device 1.

(Process of Electronic Device 1)

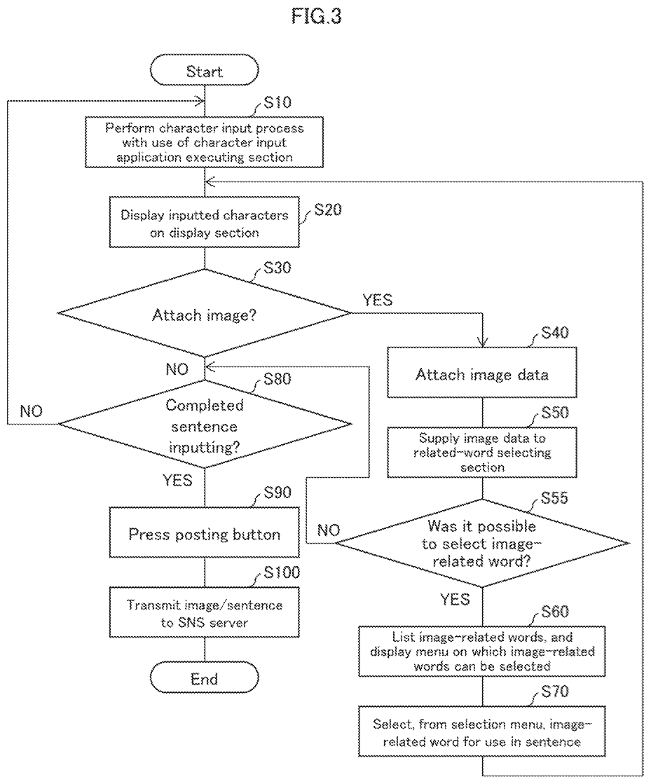

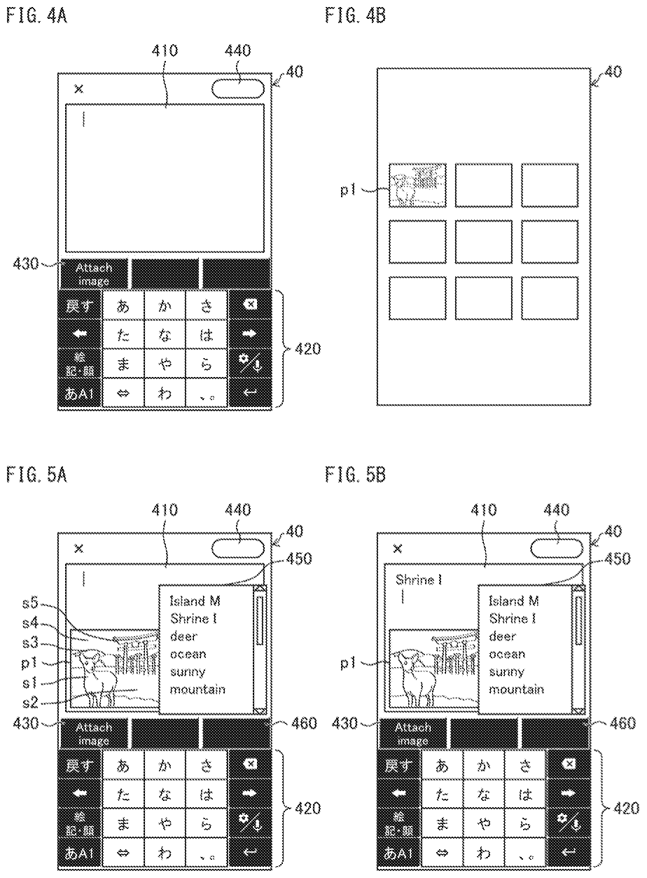

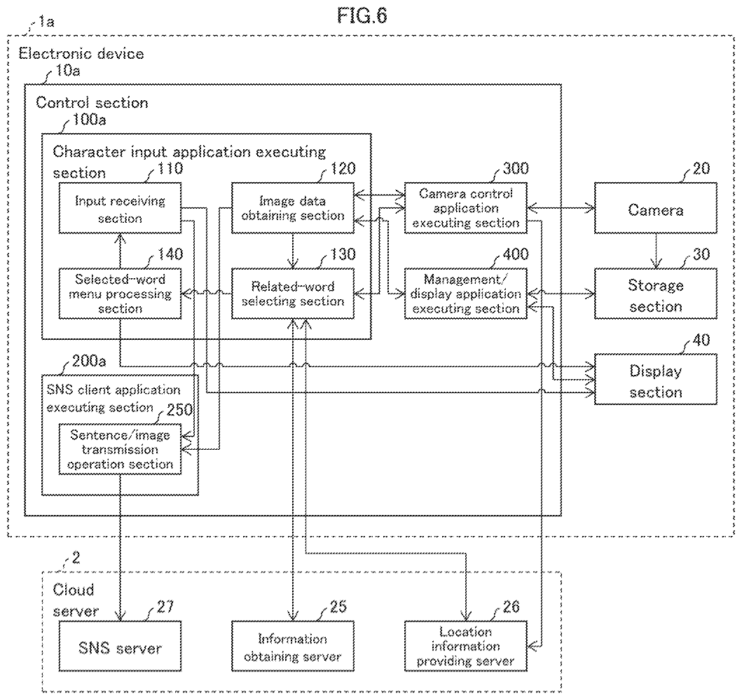

A process (control method) performed by the electronic device 1 will be described next with reference to FIGS. 3, 4A, 4B, 5A, and 5B. FIG. 3 is a flowchart illustrating the process performed by the electronic device 1. FIG. 4A is a view illustrating a content displayed by the display section 40 included in the electronic device 1. FIG. 4B is a view illustrating an image selection screen displayed by the display section 40. FIG. 5A is a view showing that a menu is displayed by the display section 40 included in the electronic device 1, the menu allowing an image-related word to be selected. FIG. 5B is a view showing that an image-related word is inputted into the display section 40.

As illustrated in FIG. 3, first, the character input application executing section 100 performs a character input process in response to an operation of a user (step S10). Specifically, the user operates the input operation section 420 illustrated in FIG. 4A. The input operation section 420 is a region displayed, by the character input application executing section 100, on a lower portion of the display section 40.

In a case where the input operation section 420 is operated by the user, the character input application executing section 100 performs the character input process with respect to an input display section 410 illustrated in FIG. 4A. The input display section 410 is a region displayed, by the input receiving section 210, on an upper portion of the display section 40. In a case where the character input application executing section 100 performs the character input process, the input receiving section 210 receives a character input from the character input application executing section 100.

In a case where the input receiving section 210 receives the character input from the character input application executing section 100, the input receiving section 210 causes the display section 40 to display the character input (step S20). The input receiving section 210 supplies, to the sentence/image transmission operation section 250, data on the inputted characters (sentence) displayed on the display section 40. Meanwhile, in a case where image data is to be attached (YES in step S30), the user presses an image attachment button 430 illustrated in FIG. 4A. The image attachment button 430 is a button displayed, by the image data obtaining section 220, between the input display section 410 and the input operation section 420 of the display section 40.

In a case where the image attachment button 430 is pressed by the user, the management/display application executing section 400 obtains a plurality of pieces of image data stored in the storage section 30. It is possible that in a case where no image data is stored in the storage section 30, the image data obtaining section 220 instructs, after the image attachment button 430 is pressed by the user, the camera control application executing section 300 to start the camera 20. In such a case, after the camera 20 is started and an image of the outside of the camera 20 is captured by an operation of the user with use of the camera 20, image data generated by capturing the image is stored in the storage section 30.

Alternatively, it is possible that after the image attachment button 430 is pressed by the user, the user selects one of (i) an operation to select image data already stored in the storage section 30 and (ii) an operation to start the camera 20.

As illustrated in FIG. 4B, the management/display application executing section 400 causes the display section 40 to display a plurality of pieces of image data (image selection screen). It is assumed here that, for example, the user has selected, of the plurality of pieces of image data, image data p1 which has been generated by the image capturing by the camera 20. In this case, the management/display application executing section 400 supplies, to the image data obtaining section 220, the image data p1 selected by the user, and causes the display section 40 to display the image data p1. Note that the user can select two or more of the plurality of pieces of image data displayed on the display section 40.

The image data obtaining section 220 obtains, as selected image data, the image data p1 supplied from the management/display application executing section 400. Then, the image data obtaining section 220 attaches, to the input display section 410, the image data p1 thus obtained (step S40). The image data obtaining section 220 also supplies the image data p1 to the sentence/image transmission operation section 250.

In a case where the image data obtaining section 220 attaches the image data p1 to the input display section 410, the image data obtaining section 220 then (i) instructs the related-word selecting section 230 to select an image-related word (described later) and (ii) supplies the image data p1 to the related-word selecting section 230 (step S50).

Then, the related-word selecting section 230 refers to the image data p1 attached to the input display section 410 by the image data obtaining section 220. In so doing, the image recognition engine 231 illustrated in FIG. 2 recognizes the image data p1, and recognizes, from the image data p1, subject-related information concerning the subjects s1 through s5 included in the image data p1 illustrated in FIG. 5A. The related-word selecting section 230 obtains, from the image recognition engine 231, the subject-related information concerning the subjects s1 through s5.

The following description will discuss a case where it was possible for the related-word selecting section 230 to select the image-related word (YES in step S55). The related-word selecting section 230 selects “deer”, “ocean”, “mountain”, “sunny” and “shrine gateway” as image-related words corresponding to respective ones of subject-related information concerning the subjects s1 through s5.

Specifically, through referring to the subject-related information concerning the subjects s1 through s5, the related-word selecting section 230 selects, as image-related words, (i) the name of the subjects s1 through s3 and s5 and (ii) the weather status in the subject s4. That is, the related-word selecting section 230 obtains, from the image recognition engine 231, the subject-related information concerning the subjects s1 through s5 included in the image data p1. Then, the related-word selecting section 230 selects the image-related words, based on the subject-related information.

In a case where it is not possible for the related-word selecting section 230 to select an image-related word based on subject-related information, the image recognition engine 231 supplies the recognized subject-related information to the information obtaining server 25. Then, the information obtaining server 25 obtains, via the Internet, information that cannot be obtained inside the electronic device 1. Then, the information obtaining server 25 supplies the information to the image recognition engine 231. Through referring to the information supplied from the information obtaining server 25 to the image recognition engine 231, the related-word selecting section 230 selects an image-related word.

The facial recognition engine 232 illustrated in FIG. 2 recognizes the image data p1, and determines that facial information concerning a face of a person as the subject is not included in the image data p1 illustrated in FIG. 5A. The facial recognition engine 232 therefore recognizes no facial information from the image data p1.

In a case where the facial information is included in the image data attached by the image data obtaining section 220, the facial recognition engine 232 recognizes the image data so as to recognize the facial information included in the image data from the image data. Then, the facial recognition engine 232 supplies the recognized facial information to the information obtaining server 25. Then, the information obtaining server 25 obtains, via the Internet, information that cannot be obtained inside the electronic device 1. Then, the information obtaining server 25 supplies the information to the facial recognition engine 232.

Through referring to the information supplied from the information obtaining server 25 to the facial recognition engine 232, the related-word selecting section 230 selects, as an image-related word, the name of a person who is the subject. Specifically, the related-word selecting section 230 obtains, from the facial recognition engine 232, facial information on the face of the person who is subject included in the image data. Then, based on the facial information, the related-word selecting section 230 selects the image-related word.

The location information obtaining section 233 illustrated in FIG. 2 recognizes the image data p1 illustrated in FIG. 5A, so that the location information obtaining section 233 obtains, as information indicating the location at which the image data p1 was captured, location information associated with the image data p1. The location information obtaining section 233 supplies the location information to the location information providing server 26.

Then, the location information providing server 26 refers to the following information: (i) the location information supplied from the location information obtaining section 233 and/or (ii) information obtained by the global positioning system (GPS) when the image data p1 was captured by the camera 20. With respect to the location information and/or the information obtained by the GPS, the location information obtaining section 233 obtains the name(s) of the location(s) via the Internet. The location information is information included in the image data p1. The information obtained by the GPS when the image was captured by the camera 20 is supplied from the camera control application executing section 300 to the location information providing server 26.

In the image data p1, in this case, the names of the locations obtained by the location information providing server 26 are “Island M” and “Shrine I”. The location information providing server 26 supplies the names of the locations, which have been obtained, to the location information obtaining section 233. Through referring to the names of locations supplied from the location information providing server 26 to the location information obtaining section 233, the related-word selecting section 230 selects “Island M” and “Shrine I” as image-related words. Specifically, the related-word selecting section 230 obtains, as information indicating the location at which the image data p1 was captured, the location information associated with the image data p1. Then, based on the location information, the related-word selecting section 230 selects the image-related words.

The environment information obtaining section 234 illustrated in FIG. 2 recognizes the image data p1, so that the environment information obtaining section 234 obtains, as information indicating an environment in which the image data p1 illustrated in FIG. 5A was captured, environment information associated with the image data p1. Specifically, in a case where the image data p1 is generated when the image was captured by the camera 20, the environment information obtaining section 234 obtains, from the camera control application executing section 300, data (environment information) concerning the settings of the camera 20.

Assume here a case where, for example, a scene for capturing a night view is set as a setting in the camera 20. In this case, through referring to data on the settings of the camera 20 obtained by the environment information obtaining section 234, the related-word selecting section 230 selects “night view” as an image-related word. That is, the related-word selecting section 230 selects the image-related word, based on the environment information obtained by the environment information obtaining section 234. Note that in a case where it was ultimately not possible for the related-word selecting section 230 to select an image-related word (NO in step S55), the process proceeds to a step S80.

The related-word selecting section 230 supplies, to the selected-word menu processing section 240, the image-related word thus selected. As illustrated in FIG. 5A, the selected-word menu processing section 240 lists the selected image-related words, and then causes the display section 40 to display the listed image-related words as a menu 450 on which an image-related words can be selected (step S60).

In so doing, the user can hide the menu 450 by pressing a list ON/OFF switching button 460 illustrated in FIG. 5A. Pressing list ON/OFF switching button 460 again allows the menu 450 to be displayed. The list ON/OFF switching button 460 is a button displayed, by the selected-word menu processing section 240, between the input display section 410 and the input operation section 420 of the display section 40. Alternatively, the switching between displaying and hiding of the menu 450 can be performed by a method other than providing the list ON/OFF switching button 460.

After the listed image-related words are displayed on the display section 40 as the menu 450 on which an image-related word can be selected, the user selects, from the menu 450, an image-related word for use in a sentence (step S70). In a case where the user selects an image-related word, the selected-word menu processing section 240 supplies, to the input receiving section 210, information indicating the image-related word selected by the user.

The input receiving section 210 refers to the information which indicates the image-related word and which was supplied from the selected-word menu processing section 240. Then, the input receiving section 210 causes the input display section 410 to display the image-related word selected by the user. Specifically, in a case where the user selects, from the menu 450, the image-related word for use in a sentence, the image-related word selected by the user is inputted into the input display section 410 as illustrated in FIG. 5B. Then, the input receiving section 210 supplies, to the sentence/image transmission operation section 250, data on (i) the inputted characters (sentence) displayed on the display section 40 and (ii) the image displayed on the display section 40.

In a case where no image data is to be attached or the attachment of the image data has been completed (NO in step S30), the process proceeds to step S80. In a case where the user has not completed inputting characters in the step S80 (NO in the step S80), the process returns to the step S10.

By repeating step S10 through step S80, the user can perform, in combination, (i) inputting of characters from the input operation section 420 and (ii) inputting of a characters from the menu 450. For example, the user can make a sentence such as “I am at Shrine I now. The weather at Island M sunny today! The deer seem to be enjoying the day.” In this sentence, the word “Shrine I”, “Island M”, “sunny”, and “deer” are inputs from the menu 450, and words other than these words are inputs from the input operation section 420.

In a case where the user completes inputting characters in the step S80 (YES in step S80), the user presses the posting button 440 displayed on the display section 40 (step S90). The posting button 440 is displayed, for example, on an upper right portion of the display section 40 as illustrated in FIG. 5A and FIG. 5B. The posting button 440 is intended for transmitting a sentence and/or an image to the SNS server 27.

In a case where the posting button 440 is pressed by the user, the sentence/image transmission operation section 250 transmits, to the SNS server 27, data on the inputted characters (sentence) and the image which are displayed on the display section 40 (step S100).

As has been described, the electronic device 1 is configured so that (i) a word relevant to selected image data is selected as an image-related word and then (ii) the image-related word is displayed, together with the selected image data, on the display section 40. Therefore, in a case where, for example, an image-related word selected by the user is to be inputted, it is possible to support the user in inputting a sentence. This makes it possible to reduce an effort and an error when the user inputs the sentence.

The electronic device 1 recognizes subject-related information concerning a subject included in image data p1. Then, based on the subject-related information, the electronic device 1 selects an image-related word. This allows an image-related word, which is based on subject-related information on the subject included in image data p1, to be displayed, together with selected image data, on the display section 40.

Furthermore, the electronic device 1 recognizes facial information concerning the face of a person as the subject included in image data. Then, based on the facial information, the electronic device 1 selects an image-related word. This allows an image-related word, which is based on facial information on the face of a person as the subject included in image data, to be displayed, together with selected image data, on the display section 40.

The electronic device 1 obtains, as information indicating an environment in which image data p1 was captured, environment information associated with the image data p1. Then, based on the environment information, the electronic device 1 selects an image-related word. This allows an image-related word, which is based on environment information associated with image data p1 and which serves as information indicating the environment in which the image data p1 was captured, to be displayed, together with selected image data, on the display section 40.

The electronic device 1 obtains, as information indicating a location at which image data p1 was captured, location information associated with the image data p1. Then, based on the location information, the electronic device 1 selects an image-related word. This allows an image-related word, which is based on location information associated with image data p1 and which serves as information indicating the location at which the image data p1 was captured, to be displayed, together with selected image data, on the display section 40.

### Embodiment 2

FIG. 6 is a block diagram illustrating a configuration of an electronic device 1a in accordance with Embodiment 2 of the present invention. For convenience, members having functions identical to those of the members described in Embodiment 1 are given identical reference signs, and their descriptions will be omitted.

As illustrated in FIG. 6, the electronic device 1a differs from the electronic device 1 in that the control section 10 is replaced with a control section 10a. The control section 10a differs from the control section 10 in that the character input application executing section 100 and the SNS client application executing section 200 are replaced with a character input application executing section 100a and an SNS client application executing section 200a, respectively.

According to the electronic device 1a, the following are provided in the character input application executing section 100a: an input receiving section 110, an image data obtaining section 120, a related-word selecting section 130, and a selected-word menu processing section 140. The input receiving section 110, the image data obtaining section 120, the related-word selecting section 130, and the selected-word menu processing section 140 perform processes identical to those of the input receiving section 210, the image data obtaining section 220, the related-word selecting section 230, and the selected-word menu processing section 240, respectively.

By thus providing the input receiving section 110, the image data obtaining section 120, the related-word selecting section 130, and the selected-word menu processing section 140 in the character input application executing section 100a, it is possible to select an image-related word with use of the character input application executing section 100a.

[Software Implementation Example]

Control blocks of the electronic device 1, 1a (particularly, the control section 10 and the control section 10a) can be realized by a logic circuit (hardware) provided in an integrated circuit (IC chip) or the like or can be alternatively realized by software.

In the latter case, the electronic device 1, 1a includes a computer that executes instructions of a program that is software realizing the foregoing functions. The computer, for example, includes at least one processor (control device) and at least one computer-readable storage medium in which the program is stored. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be supplied to or made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

[Recap]

An electronic device (1, 1a) in accordance with an aspect of the present invention includes: at least one storage section (30) in which image data is to be stored; at least one display section (40); and at least one control section (10), the at least one control section being configured to perform (a) an image data obtaining process of obtaining, from the at least one storage section, image data selected by a user, the image data being obtained as selected image data, (b) a related-word selecting process of selecting, as an image-related word, a word relevant to the selected image data, and (c) a displaying process of controlling the at least one display section to display the image-related word and the selected image data.

According to the configuration, (i) a word relevant to selected image data is selected as an image-related word and then (ii) the image-related word is displayed, together with the selected image data, on the display section. Therefore, in a case where, for example, an image-related word selected by the user is to be inputted, it is possible to support the user in inputting a sentence. This makes it possible to reduce an effort and an error when the user inputs the sentence.

An electronic device (1, 1a) in accordance with Aspect 2 of the present invention is preferably configured in Aspect 1 so that the at least one control section (10) is configured to: recognize the selected image data; obtain subject-related information concerning a subject included in the selected image data; and select, based on the subject-related information, the image-related word.

According to the configuration, the subject-related information concerning the subject included in the selected image data is obtained, and, based on the subject-related information, the image-related word is selected. This allows an image-related word, which is based on subject-related information on the subject included in the selected image data, to be displayed, together with selected image data, on the display section.

An electronic device (1, 1a) in accordance with Aspect 3 of the present invention is preferably configured in Aspect 1 or 2 so that the at least one control section (10) is configured to: recognize the selected image data; obtain facial information on a face of a person who is a subject included in the selected image data; and select, based on the facial information, the image-related word.

According to the configuration, the facial information on the face of the person who is the subject included in the selected image data is obtained, and, based on the facial information, the image-related word is selected. This allows an image-related word, which is based on facial information on the face of a person as the subject included in selected image data, to be displayed, together with selected image data, on the display section.

An electronic device (1, 1a) in accordance with Aspect 4 of the present invention is preferably configured in any one of Aspects 1 through 3 so that the at least one control section (10) is configured to: recognize the selected image data; obtain, as information indicating an environment in which the selected image data was captured, environment information associated with the selected image data; and select, based on the environment information, the image-related word.

With the configuration, an image-related word, which is based on environment information associated with selected image data and which serves as information indicating the environment in which the selected image data was captured, can be displayed, together with selected image data, on the display section.

An electronic device (1, 1a) in accordance with Aspect 5 of the present invention is preferably configured in any one of Aspects 1 through 4 so that the at least one control section (10) is configured to: recognize the selected image data; obtain, as information indicating a location at which the selected image data was captured, location information associated with the selected image data; and select, based on the location information, the image-related word.

With the configuration, an image-related word, which is based on location information associated with selected image data and which serves as information indicating the location at which the selected image data was captured, can be displayed, together with selected image data, on the display section.

A control method in accordance with Aspect 6 of the present invention is a method of controlling an electronic device (1, 1a), the electronic device including: at least one storage section (30) in which image data is to be stored; at least one display section (40); and at least one control section (10, 10a), the at least one control section being configured to perform (a) an image data obtaining process of obtaining, from the at least one storage section, image data selected by a user, the image data being obtained as selected image data, (b) a related-word selecting process of selecting, as an image-related word, a word relevant to the selected image data, and (c) a displaying process of controlling the at least one display section to display the image-related word and the selected image data. With the configuration, an effect similar to that obtained by Aspect 1 can be obtained.

A control device in accordance with Aspect 7 of the present invention is a control device configured to control an electronic device (1, 1a), the electronic device including: at least one storage section (30) in which image data is to be stored; and at least one display section (40); the control device including: (a) an image data obtaining section (220) configured to obtain, from the at least one storage section, image data selected by a user, the image data being obtained as selected image data; (b) a related-word selecting section (230) configured to select, as an image-related word, a word relevant to the selected image data; and (c) a display processing section (management/display application executing section 400) configured to control the at least one display section to display the image-related word and the selected image data. With the configuration, an effect similar to that obtained by Aspect 1 can be obtained.

The electronic device (1, 1a) in accordance with each of the foregoing aspects of the present invention can be realized by a computer. In such a case, the following can be encompassed in the scope of the present invention: a control program for the electronic device which program causes a computer to operate as each section (software element) of the electronic device so that the electronic device can be realized by the computer; and a computer-readable storage medium in which the control program is stored.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1a Electronic device
2 Cloud server
10, 10a Control section
20 Camera
25 Information obtaining server
26 Location information providing server
27 SNS server
30 Storage section
40 Display section
100, 100a Character input application executing section
110, 210 Input receiving section
120, 220 Image data obtaining section
130, 230 Related-word selecting section
140, 240 Selected word menu processing section
200, 200a SNS client application executing section
231 Image recognition engine
232 Face recognition engine
233 Location information obtaining section
234 Environment information obtaining section
250 Sentence/image transmission operation section
300 Camera control application executing section
400 Management/display application executing section
410 Input display section
420 Input operation section
430 Image attachment button
440 Posting button
450 Menu
460 List ON/OFF switching button
p1 Image data
s1 through s5 Subject

1. An electronic device comprising:
at least one storage section in which image data is to be stored;
at least one display section; and
at least one control section,
the at least one control section being configured to perform
(a) an image data obtaining process of obtaining, from the at least one storage section, image data selected by a user, the image data being obtained as selected image data,
(b) a related-word selecting process of selecting, as an image-related word, a word relevant to the selected image data, and
(c) a displaying process of controlling the at least one display section to display the image-related word and the selected image data.

2. The electronic device according to claim 1, wherein the at least one control section is configured to:
recognize the selected image data;
obtain subject-related information concerning a subject included in the selected image data; and
select, based on the subject-related information, the image-related word.

3. The electronic device according to claim 1, wherein the at least one control section is configured to:
recognize the selected image data;
obtain facial information on a face of a person who is a subject included in the selected image data; and
select, based on the facial information, the image-related word.

4. The electronic device according to claim 1, wherein the at least one control section is configured to:
recognize the selected image data;
obtain, as information indicating an environment in which the selected image data was captured, environment information associated with the selected image data; and
select, based on the environment information, the image-related word.

5. The electronic device according to claim 1, wherein the at least one control section is configured to:
recognize the selected image data;
obtain, as information indicating a location at which the selected image data was captured, location information associated with the selected image data; and
select, based on the location information, the image-related word.

6. A method of controlling an electronic device, said electronic device comprising:
at least one storage section in which image data is to be stored;
at least one display section; and
at least one control section,
the at least one control section being configured to perform
(a) an image data obtaining process of obtaining, from the at least one storage section, image data selected by a user, the image data being obtained as selected image data
(b) a related-word selecting process of selecting, as an image-related word, a word relevant to the selected image data, and
(c) a displaying process of controlling the at least one display section to display the image-related word and the selected image data.

7. A control device configured to control an electronic device,
said electronic device comprising:
at least one storage section in which image data is to be stored; and
at least one display section;
said control device comprising:
(a) an image data obtaining section configured to obtain, from the at least one storage section, image data selected by a user, the image data being obtained as selected image data;
(b) a related-word selecting section configured to select, as an image-related word, a word relevant to the selected image data; and
(c) a display processing section configured to control the at least one display section to display the image-related word and the selected image data.
